(19) United States
(12) Patent Application Publication
(10) Pub. No.: US 2024/0261905 A1
(43) Pub. Date: Aug. 8, 2024

(54) LASER PEEN FORMING DEVICE AND METHOD WITH ADJUSTABLE ABSORBING LAYER

(71) Applicant: Jiangsu University, Jiangsu (CN)

(72) Inventors: Huaile LIU, Jiangsu (CN); Xudong REN, Jiangsu (CN); Zhaopeng TONG, Jiangsu (CN); Wangfan ZHOU, Jiangsu (CN); Lan CHEN, Jiangsu (CN); Haojie YANG, Jiangsu (CN); Yongzhou GE, Jiangsu (CN)

(73) Assignee: Jiangsu University, Jiangsu (CN)

(21) Appl. No.: 18/034,068

(22) PCT Filed: Jul. 13, 2022
(86) PCT No.: PCT/CN2022/105328

§ 371 Date: Apr. 27, 2023

(30) Foreign Application Priority Data
Jun. 13, 2022 (CN) 202210661526.9

(51) Int. Cl. B23K 26/70; B23K 26/06; B23K 26/0622; B23K 26/08; C21D 10/00

(52) U.S. Cl. CPC B23K 26/702; B23K 26/0622; B23K 26/0643; B23K 26/0648; B23K 26/0861; C21D 10/005

(57) ABSTRACT

The present disclosure provides a laser peen forming device and method with an adjustable absorbing layer. The laser peen forming device with the adjustable absorbing layer includes a laser peening system, an x-y-z three-axis machining platform, and a working tank, where the working tank is secured on the x-y-z three-axis machining platform; the laser peening system is located above the working tank; a laser irradiation system and a three-dimensional information acquirer are further arranged above the working tank; a workpiece, a tool anode, a heating device, and a temperature sensor are arranged in the working tank; the workpiece is connected to a cathode of an electric box; the tool anode is connected to an anode of the electric box; the tool anode is located above the workpiece and keeps a predetermined distance from the workpiece; and the working tank is connected to a phosphating solution flowing system.

### TECHNICAL FIELD

The present disclosure belongs to the technical field of laser peening, and particularly relates to a laser peen forming device and method.

### BACKGROUND

High-accuracy and high-performance forming of panels is a key to major equipment manufacturing and also an important generic technology in the manufacturing field. Crucial components such as aerofoils of aircrafts, nose wings of bullet trains, and shell plates of ships not only determine the shapes of equipment, but also play a vital role in overall performance and service lives of the equipment. Manufacturing of these components depend on overall formation of complex panels. Complex surfaces, gradually changed structures, uneven thicknesses and the like of the panels have great impacts on formation, superposition and evolution of stresses and strains in the forming process. Existing forming technologies, including creep age forming and shot peen forming, are far from satisfactory to forming requirements. Hence, a forming method adapted for complex features and controllable in multi-dimensional parameters is desired.

Laser peen forming generally requires laser peening repeatedly. Whenever the laser peening is performed, an absorbing layer is to be changed troublesomely. Aluminum foils, black tapes or black paints are usually used as the absorbing layer. The thickness of the absorbing layer is fixed and cannot be adjusted. Therefore, there is a need to provide a novel preparation technology for the absorbing layer.

### SUMMARY

In view of shortages in the prior art, the present disclosure provides a laser peen forming device and method with an adjustable absorbing layer. By preparing a thickness-adjustable black phosphating film as an absorbing layer in laser peening, the present disclosure achieves a high forming accuracy and a simple operation process in the laser peening.

To achieve the above objective, the present disclosure adopts the following technical solutions. A laser peen forming device with an adjustable absorbing layer is provided, including a laser peening system, an x-y-z three-axis machining platform, and a working tank, where the working tank is secured on the x-y-z three-axis machining platform; the laser peening system is located above the working tank; a laser irradiation system and a three-dimensional information acquirer are further arranged above the working tank; a workpiece, a tool anode, a heating device, and a temperature sensor are arranged in the working tank; the workpiece is connected to a cathode of an electric box; the tool anode is connected to an anode of the electric box; the tool anode is located above the workpiece and keeps a predetermined distance from the workpiece; and the working tank is connected to a phosphating solution flowing system.

According to the above solutions, the laser peening system includes a first pulsed laser, a first reflector, and a first focusing lens; and a laser beam emitted from the first laser is reflected by the first reflector and then focused by the first focusing lens onto a surface of the workpiece.

According to the above solutions, the laser irradiation system includes a second pulsed laser, a second reflector, and a second focusing lens; and a laser beam emitted from the second laser is reflected by the second reflector and then focused by the second focusing lens onto the surface of the workpiece.

According to the above solutions, the workpiece is secured in the working tank through a clamp; the tool anode and a distance sensor are secured on an external fixator; and the distance sensor is configured to measure a distance from a bottom of the tool anode to the workpiece.

According to the above solutions, the phosphating solution flowing system includes a solution storage tank; a phosphating solution is provided in the solution storage tank; a water outlet of the solution storage tank is formed in the solution storage tank solution storage tank; a water inlet of the working tank and a water outlet of the working tank are formed in the working tank; and the phosphating solution in the solution storage tank flows out from the water outlet of the solution storage tank, flows into the working tank from the water inlet of the working tank, and flows out from the water outlet of the working tank after reaction.

According to the above solutions, the laser peen forming device with the adjustable absorbing layer further includes a computer and a motion controller, where the motion controller controls the x-y-z three-axis machining platform; and the computer is connected to the temperature sensor, the three-dimensional information acquirer, the heating device, the first pulsed laser, the second pulsed laser, and the electric box.

According to the above solutions, the tool anode is an inert electrode; the tool anode is a cylinder with a diameter of 0.5 mm; and a distance of 0.1 mm to 1 mm is kept between a bottom of the tool anode and the workpiece.

According to the above solutions, the tool anode is perpendicular to a plane of the workpiece; and after a laser beam emitted from a second pulsed laser passes through a second convex lens, an axis of the laser beam forms an included angle of 30° to 60° with the plane of the workpiece.

The present disclosure further provides a laser peen forming method with an adjustable absorbing layer, including the following steps: S1: opening a water outlet of a solution storage tank and a water inlet of a working tank, such that a stock solution in the solution storage tank flows out from the water outlet of the solution storage tank, and flows into the working tank from the water inlet of the working tank; and closing the water outlet of the solution storage tank and the water inlet of the working tank when a phosphating solution in the working tank reaches a predetermined height; S2: turning on a heating device to heat the phosphating solution in the working tank to a predetermined temperature; allowing a temperature sensor to feed back a temperature of the phosphating solution in the working tank in real time; and allowing a computer to control the heating device to keep the temperature constant for a predetermined time, thereby forming a black phosphating film on a surface of a workpiece, where the phosphating film on the surface serves as an absorbing layer in laser peen forming; S3: importing ultimate three-dimensional parameters of a formed panel to the computer, comparing the ultimate three-dimensional parameters with a current three-dimensional morphology of the workpiece to plan specific parameters in the laser peen forming, allowing a motion controller to control an x-y-z three-axis machining platform, and turning on a first laser to conduct the laser peen forming; S4: allowing a three-dimensional information acquirer to acquire a three-dimensional morphology of a peened workpiece, and compare the three-dimensional morphology of the peened workpiece with the ultimate three-dimensional parameters of the formed panel, to determine a region to be peened again and peening parameters; S5: allowing the motion controller to control the x-y-z three-axis machining platform, to move the region to be peened again to be below a tool anode; allowing a distance sensor to measure a distance from a bottom of the tool anode to the workpiece, and feed a measured distance back to the computer; allowing the computer to control a three-dimensional moving platform to adjust the distance between the tool anode and the workpiece; and opening a water outlet of the working tank to change the phosphating solution according to processes in the step S1; S6: turning on a second laser and an electric box at the same time, where a laser beam emitted from the second laser is focused to irradiate the surface of the workpiece, heat generated by the laser beam is thermally conducted to a surface of a local region of the workpiece, and the electric box controls a current and a voltage of the local region; and allowing the motion controller to control the x-y-z three-axis machining platform to realize localized phosphating film deposition on the local region; S7: allowing the motion controller to control the x-y-z three-axis machining platform, turning on the first laser, adjusting laser peen forming parameters, and performing the laser peen forming again on the local region where the localized phosphating film deposition is realized; and S8: repeating the steps S4-S7, ensuring that a formed workpiece falls within an allowable error range of preset parameters, and turning off all devices.

According to the above solutions, the laser for the laser peen forming is a hundred-joule-level repetitive-frequency solid state nanosecond laser with adjustable multi-dimensional parameters, including a spot size, a beam waveform, an optical field distribution, and a pulse width; a laser for laser irradiation is a picosecond laser; when the laser peen forming is performed for a first time, a square spot with a side length of 5 mm to 8 mm and laser energy of 50 J to 100 J is used; and when the laser peen forming is performed on the local region for reshaping, a circular spot with a diameter of 0.5 mm to 2 mm and laser energy of 1 J to 10 J is used.

The present disclosure has the following beneficial effects: (1) Electrolytic phosphating is a process of depositing phosphate ions of a phosphating solution on a surface of a workpiece (cathode) under an applied current. Nevertheless, both an accuracy and a region in the electrolytic phosphating are controlled hardly. With assistance of laser irradiation, the current density in a critical reaction can be improved, and the electrolytic phosphating is realized in the local region to deposit the phosphating film. The electrolytic phosphating reaction in the local region can be accelerated with thermal effects of the laser, and the flowing of the phosphating solution near the region can be improved with force effects of the laser, thereby removing bubbles nearby timely. On the other hand, the laser irradiation reduces activation energy of reactive electrons, and inhibits concentration polarization. Consequently, the reaction is carried out continuously and stably to refine grains, which improves a flatness of the phosphating film. (2) As the absorbing layer in the laser peen forming, the black phosphating film has a high laser absorptivity, and is unnecessary to be removed upon completion of the laser peen forming. This improves wear resistance and corrosion resistance of the formed workpiece. (3) High-energy large spots are formed efficiently, while low-energy spots are formed accurately. This improves the forming accuracy of the panel, and saves the forming time. (4) Localized phosphating film deposition collaborates laser thermal effects with the electrolytic phosphating. The present disclosure deposits the phosphating film in a special region, and does not cause a phosphating reaction in other regions without laser peening again, thereby simplifying a coating process of the absorbing layer. This greatly saves coating time of the absorbing layer.

### Solution to Problem

### BRIEF DESCRIPTION OF THE DRAWINGS

FIG. 1 is a structural schematic view of a device according to the present disclosure.

FIG. 2 is a flow chart of a method according to an embodiment of the present disclosure.

FIG. 3 illustrates a macroscopic morphology of a surface on a phosphating film according to an embodiment.

FIG. 4 illustrates a microscopic morphology of a surface on a phosphating film according to an embodiment.

FIG. 5 illustrates a morphology of a cross section of a phosphating film according to an embodiment.

FIG. 6 illustrates a macroscopic morphology of a peened surface according to an embodiment.

FIG. 7 illustrates surface residual stresses of different treated samples according to an embodiment.

### DETAILED DESCRIPTION OF THE EMBODIMENTS

The technical solutions of the present disclosure are described in more detail below with reference to the accompanying drawings.

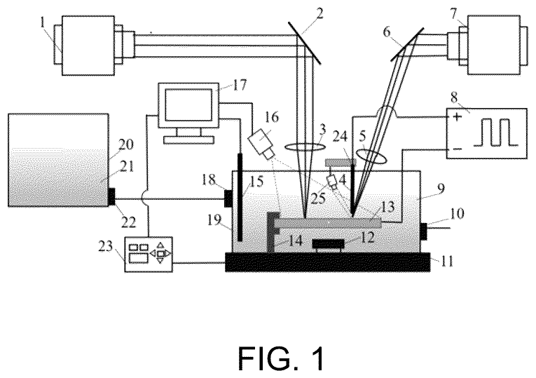

As shown in FIG. 1, an embodiment provides a laser peen forming device with an adjustable absorbing layer, including a laser peening system, a laser irradiation system, an electrolytic phosphating system, a motion control system, a phosphating solution flowing system, an information acquisition system, and a heating system. The laser peening system includes a first pulsed laser 1, a first reflector 2, and a first focusing lens 3. A laser beam emitted from the first laser 1 is reflected by the first reflector 2 and then focused by the first focusing lens 3 to a surface of a workpiece 13. The laser irradiation system includes a second pulsed laser 7, a second reflector 6, and a second focusing lens 5. A laser beam emitted from the second laser 7 is reflected by the second reflector 6 and then focused by the second focusing lens 6 onto the surface of the workpiece 13. The electrolytic phosphating system includes an electric box 8, the workpiece 13, and a tool anode 4. The workpiece 13 is connected to a cathode of the electric box 8, and secured below a working tank 19 through a clamp 14. The tool anode 4 is connected to an anode of the electric box 8 and secured above the workpiece 13, and keeps a predetermined distance from the workpiece 13. The tool anode 4 and a distance sensor 25 are secured to an external fixator 24. The distance sensor 25 is configured to measure a distance from a bottom of the tool anode to the workpiece. The motion control system includes a computer 17 and a motion controller 23. The motion controller 23 controls an x-y-z three-axis machining platform 11. The heating system includes the computer 17 and a heating device 12. The information acquisition system includes the computer 17, a temperature sensor 15, and a three-dimensional information acquirer 16. The temperature sensor acquires a temperature of a phosphating solution in the working tank 19 in real time, and feeds the temperature back to the computer 17. The three-dimensional information acquirer 16 acquires a morphology change of a peened workpiece 13, and feeds the morphology change back to the computer 17. The computer 17 controls the first pulsed laser 1, the second pulsed laser 7, the heating device 12, and the electric box 8. The phosphating solution flowing system includes a solution storage tank 20, a phosphating solution 21, a water outlet 22 of the solution storage tank, a water inlet 18 of the working tank, and a water outlet 10 of the working tank. The stock solution 21 in the solution storage tank 20 flows out from the water outlet 22 of the solution storage tank, flows into the working tank from the water inlet 18 of the working tank, and flows out from the water outlet 10 of the working tank after reaction.

Preferably, the first pulsed laser 1 is a hundred-joule-level repetitive-frequency solid state nanosecond laser with adjustable multi-dimensional parameters, including a spot size, a beam waveform, an optical field distribution and a pulse width. The second pulsed laser 7 is a picosecond laser.

Preferably, the tool anode 4 is an inert electrode. The tool anode is a cylinder with a diameter of 0.5 mm. One segment of the tool anode is close to the workpiece at a distance of 0.1 mm to 1 mm. The electric box is configured to control a current and a voltage in an electrolytic phosphating tank. An axis of the cylinder of the tool anode 4 is perpendicular to a surface of the workpiece 13. After a laser beam emitted from the second pulsed laser 7 passes through a second convex lens 5, an axis of the laser beam forms an included angle of 30° to 60° with the workpiece. The distance sensor 25 is configured to measure the distance from the bottom of the tool anode to the workpiece, and feeds the measured distance back to the computer. The computer controls a three-dimensional moving platform to adjust the distance between the tool anode and the workpiece.

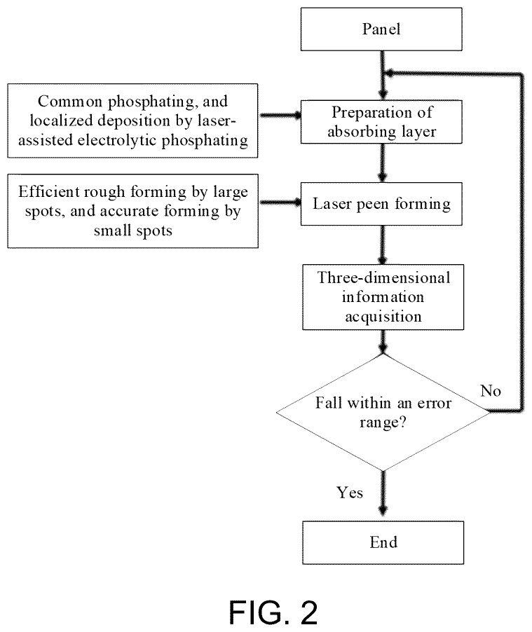

An embodiment provides a laser peen forming method with an adjustable absorbing layer, including the following steps as shown in FIG. 2. S1: A water outlet of a solution storage tank 20 and a water inlet 18 of a working tank are opened, such that a stock solution 21 in the solution storage tank 20 flows out from the water outlet 22 of the solution storage tank, and flows into the working tank from the water inlet 18 of the working tank. When a phosphating solution in the working tank reaches a predetermined height, the water outlet of the solution storage tank 20 and the water inlet 18 of the working tank are closed. S2: A heating device 12 is turned on to heat the phosphating solution 9 in the working tank 19 to a predetermined temperature. A temperature sensor 15 feeds back the temperature of the phosphating solution in the working tank in real time. A computer controls the heating device to keep the temperature constant for a predetermined time, thereby forming a black phosphating film on a surface of a workpiece. The phosphating film on the surface serves as an absorbing layer in laser peen forming. S3: Ultimate three-dimensional parameters of a formed panel are imported to the computer, and compared with a current three-dimensional morphology of the workpiece to plan specific parameters in the laser peening. A motion controller 23 controls an x-y-z three-axis machining platform 11. A first laser is turned on to conduct the laser peen forming. S4: A three-dimensional information acquirer 16 acquires a three-dimensional morphology of a peened workpiece obtained in S3, and compares the three-dimensional morphology of the peened workpiece with the ultimate three-dimensional parameters of the formed panel, to determine a region to be peened again. S5: The motion controller 23 controls the x-y-z three-axis machining platform 11, to move the region to be peened again to be below a tool anode 4. A water outlet 10 of the working tank is opened to change the phosphating solution according to processes in the step S1. S6: A second laser and an electric box are turned on at a same time. A laser beam emitted from the second laser is focused to irradiate the surface of the workpiece. Heat generated by the laser beam is thermally conducted to a surface of a local region of the workpiece. The electric box controls a current and a voltage of the local region. The motion controller controls the x-y-z three-axis machining platform to realize localized phosphating film deposition on the local region. S7: The motion controller controls the x-y-z three-axis machining platform. The first laser is turned on. Laser peen forming parameters are adjusted. The laser peening is performed again on a region where a phosphating film is deposited directionally. S8: The steps S4-S7 are repeated. It is ensured that a formed workpiece falls within an allowable error range of preset parameters. All devices are turned off.

Preferably, the electrolytic phosphating solution includes 10-20 ml/L phosphoric acid, 2.5-3 g/L sodium m-nitrobenzenesulfonate, 0.5-1 g/L tartaric acid, 3-5 g/L magnesium hydroxide, and the balance deionized water. In the localized phosphating film deposition on the local region, an electrolytic tank uses a direct current at a density of 0.5 A/dm² to 50 A/dm². In the localized phosphating film deposition on the local region, the second laser generator provides a pulsed light source, with main parameters including a wavelength (1,064 nm), a spot diameter (20 μm), a pulse width (12 ps), an output power of 10 W to 20 W, and a scan spacing of 10 μm to 40 μm. In the localized phosphating film deposition on the local region, the computer (17) turns on the second laser generator and the electric box at the same time. When the local region satisfies a phosphating film deposition condition, a phosphating film is deposited in the local region. As an absorbing layer in the laser peen forming, the black phosphating film has a flaky surface and a high laser absorptivity.

Preferably, before the first large-area peening, a thickness of the absorbing layer can be adjusted according to parameters in the laser peening. The thickness of the absorbing layer can be adjusted according to a heating temperature and heating time in preparation of the phosphating film. The heating temperature is in a range of 50° ° C. to 60° C., and the heating time lasts for 5-10 min.

Preferably, before the local peening, a thickness of the absorbing layer can be adjusted according to parameters in the laser peening. The thickness of the absorbing layer can be adjusted according to a current density when a localized phosphating film is prepared and laser irradiation parameters of the second laser. Whenever the laser peening is performed, the three-dimensional information acquirer (16) acquires a three-dimensional morphology of the formed workpiece, transmits it to the computer, and compares it with initial preset parameters, to determine a region and parameters for local laser peening.

Preferably, upon completion of the laser peen forming, it is unnecessary to remove the residual absorbing layer on the surface. This improves wear resistance and corrosion resistance of the workpiece. The transparent phosphating solution servers as a confining layer in the laser peen forming, with a depth dominated by a liquid level of the phosphating solution.

Preferably, when the laser peen forming is performed for a first time, a square spot with a side length of 5 mm to 8 mm and laser energy of 50 J to 100 J is used. When local laser peening is performed for reshaping, a circular spot with a diameter of 0.5 mm to 2 mm, and laser energy of 1 J to 10 J is used.

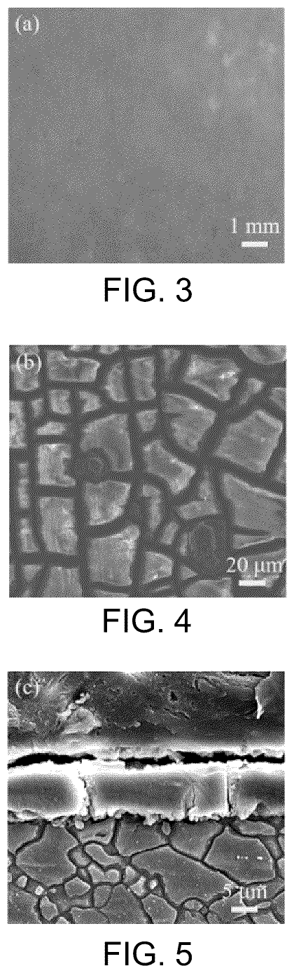

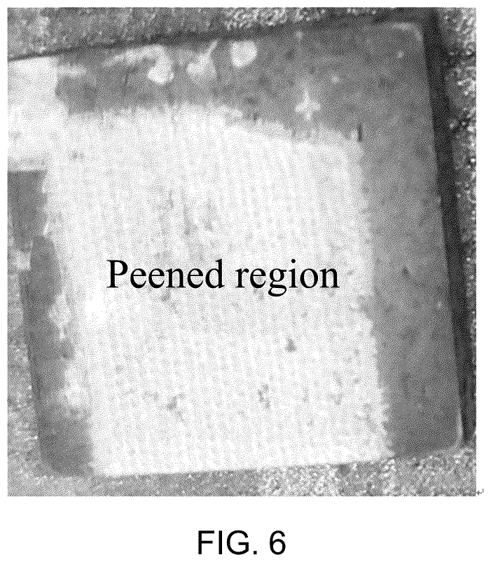

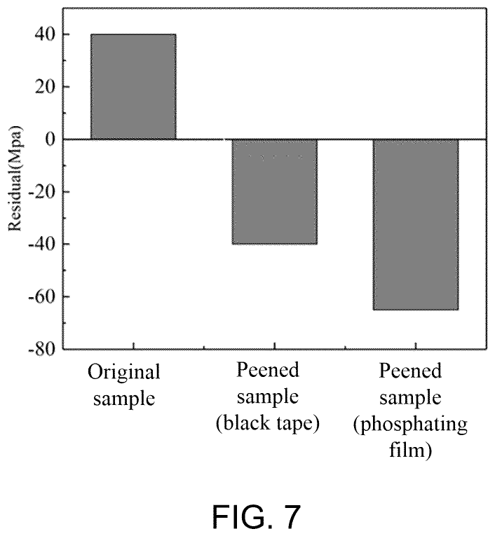

Implementation example: The electrolytic phosphating solution includes 10 ml/L phosphoric acid, 2.5 g/L sodium m-nitrobenzenesulfonate, 0.5 g/L tartaric acid, 3 g/L magnesium hydroxide, and the balance being deionized water. Heating phosphating is used for a phosphating test. Then, a laser peen forming test is performed. The phosphating solution is heated for 10 min at 60° C. The morphology of the sample on the surface of the phosphating film is shown in FIG. 3 to FIG. 5, the surface is ash black, and the coating has a thickness of greater than 10 μm. As shown in FIG. 6, upon the laser peen forming, the coating on the surface of the sample is removed obviously, and there is no evident ablation. As shown in FIG. 7, when the laser peening has energy of 3 J, the phosphating film as the absorbing layer has a surface residual stress of −65 Mpa, while the black tape as the absorbing layer has a surface residual stress of −40 Mpa. It is evident that the phosphating film as the absorbing layer outperforms the black tape as the absorbing layer in the peening effect.

1. A laser peen forming device with an adjustable absorbing layer, comprising a laser peening system, an x-y-z three-axis machining platform, and a working tank, wherein the working tank is secured on the x-y-z three-axis machining platform; the laser peening system is located above the working tank; a laser irradiation system and a three-dimensional information acquirer are further arranged above the working tank; a workpiece, a tool anode, a heating device, and a temperature sensor are arranged in the working tank; the workpiece is connected to a cathode of an electric box; the tool anode is connected to an anode of the electric box; the tool anode is located above the workpiece and keeps a predetermined distance from the workpiece; and the working tank is connected to a phosphating solution flowing system.

2. The laser peen forming device with the adjustable absorbing layer according to claim 1, wherein the laser peening system comprises a first pulsed laser, a first reflector, and a first focusing lens; and a laser beam emitted from the first pulsed laser is reflected by the first reflector and then focused by the first focusing lens onto a surface of the workpiece.

3. The laser peen forming device with the adjustable absorbing layer according to claim 2, wherein the laser irradiation system comprises a second pulsed laser, a second reflector, and a second focusing lens; and a laser beam emitted from the second pulsed laser is reflected by the second reflector and then focused by the second focusing lens onto the surface of the workpiece.

4. The laser peen forming device with the adjustable absorbing layer according to claim 3, wherein the workpiece is secured in the working tank through a clamp; the tool anode and a distance sensor are secured on an external fixator; and the distance sensor is configured to measure a distance from a bottom of the tool anode to the workpiece.

5. The laser peen forming device with the adjustable absorbing layer according to claim 4, wherein the phosphating solution flowing system comprises a solution storage tank; a phosphating solution is provided in the solution storage tank; a water outlet of the solution storage tank is formed in the solution storage tank; a water inlet of the working tank and a water outlet of the working tank are formed in the working tank; and the phosphating solution in the solution storage tank flows out from the water outlet of the solution storage tank, flows into the working tank from the water inlet of the working tank, and flows out from the water outlet of the working tank after reaction.

6. The laser peen forming device with the adjustable absorbing layer according to claim 4, further comprising a computer and a motion controller, wherein the motion controller controls the x-y-z three-axis machining platform; and the computer is connected to the temperature sensor, the three-dimensional information acquirer, the heating device, the first pulsed laser, the second pulsed laser, and the electric box.

7. The laser peen forming device with the adjustable absorbing layer according to claim 1, wherein the tool anode is an inert electrode; the tool anode is a cylinder with a diameter of 0.5 mm; and a distance of 0.1 mm to 1 mm is kept between a bottom of the tool anode and the workpiece.

8. The laser peen forming device with the adjustable absorbing layer according to claim 1, wherein the tool anode is perpendicular to a plane of the workpiece; and after a laser beam emitted from a second pulsed laser passes through a second convex lens, an axis of the laser beam forms an included angle of 30° to 60° with the plane of the workpiece.

9. A laser peen forming method with an adjustable absorbing layer, comprising the following steps:
S1: opening a water outlet of a solution storage tank and a water inlet of a working tank, such that a stock solution in the solution storage tank flows out from a water outlet of the solution storage tank, and flows into the working tank from the water inlet of the working tank; and closing the water outlet of the solution storage tank and the water inlet of the working tank when a phosphating solution in the working tank reaches a predetermined height;
S2: turning on a heating device to heat the phosphating solution in the working tank to a predetermined temperature; allowing a temperature sensor to feed back a temperature of the phosphating solution in the working tank in real time; and allowing a computer to control the heating device to keep the temperature constant for a predetermined time, thereby forming a black phosphating film on a surface of a workpiece, wherein the phosphating film on the surface serves as an absorbing layer in laser peen forming;
S3: importing ultimate three-dimensional parameters of a formed panel to the computer, comparing the ultimate three-dimensional parameters with a current three-dimensional morphology of the workpiece to plan specific parameters in the laser peen forming, allowing a motion controller to control an x-y-z three-axis machining platform, and turning on a first laser to conduct the laser peen forming;
S4: allowing a three-dimensional information acquirer to acquire a three-dimensional morphology of a peened workpiece obtained in the step S3, and compare the three-dimensional morphology of the peened workpiece with the ultimate three-dimensional parameters of the formed panel, to determine a region to be peened again and peening parameters;
S5: allowing the motion controller to control the x-y-z three-axis machining platform, to move the region to be peened again to be below a tool anode; allowing a distance sensor to measure a distance from a bottom of the tool anode to the workpiece, and feed a measured distance back to the computer; allowing the computer to control the x-y-z three-axis machining platform to adjust the distance between the tool anode and the workpiece; and opening a water outlet of the working tank to change the phosphating solution according to processes in the step S1;
S6: turning on a second laser and an electric box at the same time, wherein a laser beam emitted from the second laser is focused to irradiate the surface of the workpiece, heat generated by the laser beam is thermally conducted to a surface of a local region of the workpiece, and the electric box controls a current and a voltage of the local region; and allowing the motion controller to control the x-y-z three-axis machining platform to realize localized phosphating film deposition on the local region;
S7: allowing the motion controller to control the x-y-z three-axis machining platform, turning on the first laser, adjusting laser peen forming parameters, and performing the laser peen forming again on the local region where the localized phosphating film deposition is realized; and
S8: repeating the steps S4-S7, ensuring that a formed workpiece falls within an allowable error range of preset parameters, and turning off all devices.

10. The laser peen forming method with the adjustable absorbing layer according to claim 9, wherein the laser for the laser peen forming is a hundred-joule-level repetitive-frequency solid state nanosecond laser with adjustable multi-dimensional parameters, comprising a spot size, a beam waveform, an optical field distribution and a pulse width; a laser for laser irradiation is a picosecond laser; when the laser peen forming is performed for a first time, a square spot with a side length of 5 mm to 8 mm and laser energy of 50 J to 100 J is used; and when the laser peen forming is performed on the local region for reshaping, a circular spot with a diameter of 0.5 mm to 2 mm, and laser energy of 1 J to 10 J is used.
